(19) United States
(12) Patent Application Publication
(10) Pub. No.: US 2004/0196833 A1
(43) Pub. Date: Oct. 7, 2004

(54) Distributed gateway for combined communication services

(76) Inventors: Udi Dahan, Maalot (IL); Abraham Fisher, Haifa (IL)

Correspondence Address: William H Dippert, Reed Smith, 29th Floor, 599 Lexington Avenue, New York, NY, 10022-7650, US

(21) Appl. No.: 10/488,410

(22) PCT Filed: Aug. 28, 2001
(86) PCT No.: PCT/IL01/00802

(51) Int. Cl. H04L 12/66

(52) U.S. Cl. 370/352; 370/493

(57) ABSTRACT

A method of converting voice signals into voice packets. The method includes providing one or more of voice or fax digital signals, at a first location, processing the provided digital signals at the first location, transmitting the processed digital signals to a second location, adding at least one header to the processed digital signals transmitted to the second location, at the second location and transmitting the processed digital signals with the added header on a communication network.

### FIELD OF THE INVENTION

The present invention relates to communication systems and in particular to systems for transmission of VoIP packets.

### BACKGROUND OF THE INVENTION

Many telephone users connect to the Internet using their telephone line. A user modem establishes a modem connection with an Internet service provider (ISP) using the user's telephone line. During this time, the telephone line cannot be used simultaneously for standard telephone calls, and incoming calls are responded to with a busy signal or produce a call-waiting signal.

The V.92 ITU recommendation suggests provisions for putting the modern connection on hold while carrying out a different call. Thus, for example, a user may respond to incoming calls or may initiate outgoing calls, while being connected to the Internet. It is noted, however, that voice and modem signals are not transmitted at the same time.

Digital simultaneous voice and data (DSVD) modems defined in the V.70 ITU recommendation (08/96), the disclosure of which is incorporated herein by reference, allow end users connected over a modem connection to exchange both data and voice signals concurrently. The use of DSVD modems for concurrent transmission of voice and data requires that both the end users have compatible DSVD modems. In addition, the voice and data signals are directed to the same remote end user, and the voice signals transmitted on a DSVD connection do not include addressing information.

U.S. Pat. No. 5,870,465 to Hosbach et al., U.S. Pat. No. 5,889,845 to Staples et al. and U.S. Pat. No. 5,764,639 to Staples et al., the disclosures of which are incorporated herein by reference, describe a telecommunication system, which provides a user with a virtual presence in an office or ISP. The U.S. Pat. No. 5,870,465 patent uses a simultaneous voice and data (SVD) modem connection, for example a DSVD modem connection, between the user's residence and the office to allow the user to access the office computer (or the Internet in the case of an ISP) and concurrently conduct telephone calls using the office telephone line.

U.S. Pat. No. 6,243,377 to Phillips et al., the disclosure of which is incorporated herein by reference, describes a method of transmitting voice and data signals simultaneously over a single telephone line between subscriber premises and a communication service provider, e.g., a central office (CO). The bandwidth of the telephone line is divided into two or more TDM channels. Respective multiplexers, installed at the subscriber premises and the CO, multiplex and demultiplex data and voice signals transmitted to and from the subscriber premises. The method of the U.S. Pat. No. 6,243,377 patent requires dedicated hardware being installed at the central office. In addition, this method defines a strict distribution of the bandwidth between the voice signals and the data signals.

In recent years, voice over IP (VoIP) has become an attractive alternative to the plain old telephone system (POTS), especially for long distance calls. VoIP calls pass on the Internet and/or on private IP networks and are generally much cheaper than calls passing on switched telephone networks.

VoIP services are defined in the H.323 ITU recommendation, for example, in the 09/99 version, the disclosure of which is incorporated herein by reference. VoIP packets include an IP header, a UDP header, a real-time transport protocol (RTP) header and a payload portion carrying compressed voice data. Generally, the headers take up about 75% of the VoIP packets. Therefore, VoIP gateways are generally connected to packet based networks through broadband connections.

Some VoIP telephone carriers provide a network of gateways which connect regular telephones to a packet based network which carries telephone calls. A user desiring to carry out a telephone call, connects to a local gateway using a public switched telephone network (PSTN) and provides the destination telephone number to the gateway. The local gateway, in turn, establishes a connection on a packet based network with a remote gateway close to the destination, which in turn forms a PSTN connection with the destination telephone. After the connections are established, the gateways convert PSTN voice signals into VoIP packets and vice versa. In this VoIP service, the user's telephone line is used only for the telephone service and cannot be used concurrently for data transmission.

A user may also conduct a VoIP telephone call from his/her computer. The computer receives user voice signals, for example through a microphone associated with the computer, packs the voice signals into VoIP packets and transfers the packets to a remote gateway near the destination of the call or to a remote computer and/or server which supports VoIP.

A residential VoIP service, referred to as a digital telephone service, such as the Voicenet Communications digital telephone service (described at http://www.voicenet.com /dts1/dts_how.htm, available on Aug. 9, 2001), the net2phone broadband voice solutions (described at http://www.net2phone.com/broadband, available on Aug. 9, 2001) and the IP phone available from Telrad Israel, allows subscribers to transfer telephone conversations over the Internet while transferring data on the same telephone line. In accordance with the digital telephone service, a gateway in a subscriber's premises is used to convert telephone voice signals into VoIP packets directed to a remote gateway adjacent the destination of the voice signals. The VoIP packets are transmitted through an Internet service provider (ISP), generally over a broadband data connection between the subscriber's premises and the ISP, to the Internet, in which the packets are directed to the remote gateway. The remote gateway converts the VoIP packets back into voice signals and passes the signals over the PSTN to the destination telephone. The ISP generally does not differentiate between VoIP packets and data packets and handles them in the same manner. Telephone conversations and other voice applications using these systems may suffer from low quality due to delay and jitter associated with the Internet. In addition, the bandwidth required for such voice applications substantially limits the use of these systems to users having broadband connections to their ISP.

### SUMMARY OF THE INVENTION

An aspect of some embodiments of the present invention relates, referring without loss of generality to transmission of signals in the uplink direction, to a distributed method of converting voice and/or fax signals, from a user telephone or fax machine, into VoIP/FoIP packets, suitable for transmission on an addressable packet based network. In accordance with the method, the conversion is performed in at least two stages performed by at least two distinct entities. For example, a first stage may be performed at a subscriber's premises, while a second stage is performed at an ISP serving as a gateway to the Internet and/or to a VoIP network. Alternatively, the second stage may be performed, for example, at a central office (CO) connected to the subscriber's premises through a twisted pair.

In some embodiments of the invention, a first VoIP/FoIP conversion stage includes converting analog voice/fax signals into digital signals and a second stage includes adding RTP or T.38, UDP and IP headers to the digital signals. Alternatively or additionally, the first stage includes compressing the digital signals. Performing the VoIP/FoIP conversion in two stages, allows transmitting low capacity signals between the subscriber and the ISP, thus reducing the bandwidth requirements of the connection between the subscriber and the ISP, while still transmitting to a remote gateway standard VoIP/FoIP packets.

An aspect of some embodiments of the present invention relates to passing a plurality of voice and/or fax telephone calls on a single voice band modem (VBM) connection, passing on a single twin pair line. Optionally, the VBM connection is used to transfer data, in addition to the voice calls. Possibly, the telephone and/or fax calls are directed to at least two different locations. Furthermore, in some embodiments of the invention, the telephone and/or fax calls are directed over a plurality of different networks.

Voice band modem (VBM) connections generally have a low bandwidth, e.g., up to 33,600 bps in the up-link direction. In some embodiments of the invention, the VBM connection does not carry for at least some of the voice and/or fax calls one or more standard VoIP headers. Therefore, the bandwidth required by the voice and/or fax calls is substantially reduced, relative to transmitting standard VoIP/FoIP packets, and a plurality of calls can fit on a single VBM connection.

An aspect of some embodiments of the present invention relates to a remote access server (RAS) which serves as a gateway for voice and/or fax signals, received from user premises over a modem connection, to both a packet based network and a switched network. In some embodiments of the invention, for each telephone and/or fax call initiated by the user, the user and/or the RAS select a network to carry the call. Optionally, the selection is performed based on the time, date, the destination of the call and/or the load on one or more of the networks; In some embodiments of the invention, the RAS directs different calls from a single user premises to different networks. Alternatively or additionally, all the telephone calls from a single user premises, at a single time, are passed on the same network. Selecting the network used for a specific call, allows the user to achieve cheaper rates and/or better services for the call. In addition, selecting the network for each call, by the user and/or by the RAS, allows better distribution of calls between the networks, so as to achieve better bandwidth utilization of the networks.

An aspect of some embodiments of the present invention relates to a RAS that receives a stream of modem packets over a modem connection, handles first and second groups of packets of the modem connection differently, and forwards all the packets of the first and second groups on packet based networks. Optionally, the first and second groups of packets are forwarded on the same packet based network. Alternatively, the first and second groups of packets are forwarded on different packet based networks. Thus, the modem connection can carry different types of data, including some data which is completed into a standard format by the RAS. The completion of the data into a standard format by the RAS, reduces the bandwidth consumption of the data on the modem connection, allowing transmission of more data on the connection.

In some embodiments of the invention, the first group of packets comprises data packets and the second group of packets comprises fax and/or voice packets. The different handling optionally includes generating packet headers for the contents of the packets of the second group and forwarding the packets of the first group without adding headers.

Optionally, the first group of packets includes voice or fax packets, which are to be handled as data packets, for example because they are standard VoIP/FoIP packets. Alternatively or additionally, the stream of modem packets includes a third group of packets, for example voice packets not forwarded on a packet based network.

An aspect of some embodiments of the present invention relates to a method of transmitting voice and/or fax signals on a modem connection. The method includes encoding the voice signals according to an encoding scheme selected from a plurality of voice and/or fax encoding schemes. In some embodiments of the invention, the different encoding schemes differ in their bandwidth requirements. Optionally, the encoding scheme is selected responsive to an amount of available bandwidth on the modem connection.

In some embodiments of the invention, the modem connection carries a plurality of voice/fax connections encoded in accordance with different encoding schemes.

An aspect of some embodiments of the present invention relates to a method of transmitting fax signals on a single modem connection, together with data signals. When the fax and data signals are received by a remote access server (RAS), for example, in a CO or in an ISP, the RAS separates the fax and data signals and handles the fax and data signals separately. The fax signals may be forwarded on the same network as the data signals, or on a different network. In an exemplary embodiment of the invention, the data signals are forwarded on the Internet and the fax signals are forwarded on a switched network, e.g., the PSTN, or on a VoIP network. In some embodiments of the invention, the handling of the fax signals includes adding one or more packet headers with addressing information for transmission on an addressable packet based network.

An aspect of some embodiments of the present invention relates to transmitting data over a VBM modem connection, between a user modem and a remote modem, without the user modem being controlled by an active computer. Thus, the modem connection may be used, for example, for voice and fax signals, without a computer controlling the modem being constantly operative.

In some embodiments of the invention, the VBM modem is configured with details required to establish a connection, e.g., a telephone number to dial, a user name and/or a password. Optionally, the modem may be configured by a computer to which the modem is connected.

In some embodiments of the invention, the VBM modem includes a button or other user interface, through which a user may instruct the modem to establish a connection. Alternatively or additionally, whenever the modem receives power it attempts to establish a connection. Further alternatively or additionally, the modem is configured with a time schedule of when the connection should be established.

There is therefore provided in accordance with an embodiment of the present invention, a method of converting voice signals into voice packets, comprising providing one or more of voice or fax digital signals, at a first location, processing the provided digital signals at the first location, transmitting the processed digital signals to a second location, adding at least one header to the processed digital signals transmitted to the second location, at the second location, and transmitting the processed digital signals with the added header on a communication network. Optionally, providing the digital signals comprises receiving analog signals and converting the analog signals into digital signals and/or receiving digital signals. Optionally, processing the provided digital signals comprises compressing the voice digital signals. Optionally, compressing the voice digital signals comprises compressing according to a compression method selected responsive to at least one parameter of a connection on which the signals are transmitted. Optionally, the compression method is selected responsive to a utilization rate of the bandwidth of the connection. Optionally, the compression method is selected responsive to a data rate of the connection.

Optionally, the compression method is selected responsive to a maximal number of telephone and fax calls defined for the connection. Possibly, the method includes changing, for at least one telephone call, the compression method selected for the call, or a parameter of the compression method, during the progress of the call, without disconnecting the call.

Optionally, compressing the voice digital signals comprises compressing using a method different than a compression method used for signals transmitted in an opposite direction on a call to which the compressed signals belong. Optionally, providing the digital signals comprises providing digital voice signals and wherein processing the provided digital voice signals comprises encoding the voice signals. Optionally, providing the digital signals comprises providing digital modulated signals and wherein processing the provided digital signals comprises demodulating the digital signals. Optionally, providing the digital signals comprises providing digital fax signals and wherein processing the provided digital fax signals comprises encapsulating the fax signals into Internet facsimile protocol (IFP) packets. Optionally, transmitting the processed digital signals to a second location comprises transmitting over a modem connection. Optionally, transmitting the processed digital signals over a modem connection comprises transmitting over a voice band modem connection. Optionally, the modem connection is established other than by an instruction from a general purpose computer. Optionally, transmitting the processed digital signals to a second location comprises transmitting over an ISDN connection. Optionally, transmitting the processed digital signals to a second location comprises transmitting over a connection which additionally carries data packets. Optionally, the first and second locations are distanced from each other by at least 100 meters. Optionally, the first and second locations are not connected directly through a twin pair line. Optionally, adding at least one header to the processed digital signals transmitted to the second location comprises adding at least one of an IP, TCP, UDP, ATM or RTP header.

Optionally, adding at least one header to the processed digital signals transmitted to the second location comprises adding a header which includes one or more of a source or destination address. Optionally, providing one or more of voice or fax digital signals comprises providing signals belonging to a plurality of telephone or fax calls or a combination of one or more telephone calls and one or more fax calls.

Optionally, transmitting the processed digital signals with the added header on a communication network comprises transmitting processed digital signals from at least two different calls on at least two different communication networks. Alternatively, transmitting the processed digital signals with the added header on a communication network comprises transmitting substantially all the processed digital signals on a same communication network.

Optionally, transmitting the processed digital signals with the added header on a communication network comprises transmitting at least some of the processed digital signals with the added header on the Internet. Optionally, transmitting the processed digital signals with the added header on a communication network comprises transmitting at least some of the processed digital signals with the added header on a VoIP network or an ATM network.

There is further provided in accordance with an embodiment of the present invention, a network gateway, comprising at least one modem interface adapted to form a modem connection with a remote modem, at least one multiplexer adapted to extract one or more of voice or fax signals belonging to one or more calls, from signals received over the modem connection, at least one switched network interface adapted to transmit one or more of voice or fax signals extracted by the multiplexer, over a switched network, to a remote telephone or fax machine, and at least one packet network interface adapted to transmit one or more of voice or fax signals extracted by the multiplexer to a remote gateway, over at least one packet based network. Optionally, the at least one modem interface comprises at least one voice band modem interface and/or at least one ISDN interface. Optionally, the at least one multiplexer is adapted to extract both voice and fax signals from the signals received over the modem connection. Optionally, at any particular time the one or more of voice or fax signals extracted from the modem connection are transmitted either by the switched network interface or by the packet network interface. Optionally, the switched network interface and the packet network interface are adapted to concurrently transmit one or more of voice or fax signals extracted from the modem connection. Optionally, the at least one modem interface is remotely located from a central office servicing the remote modem.

Possibly, the gateway includes a selection unit adapted to select a network on which to transmit voice or fax signals of a call passing on the modem connection. Optionally, the selection unit selects the network on which to transmit the voice or fax signals of a call responsive to a time or date of initiation of the call and/or responsive to a destination of the call. Optionally, the selection unit selects the network on which to transmit the voice or fax signals responsive to a measure of the load on one or more of the networks. Optionally, the at least one packet network interface is adapted to transmit data packets in addition to the voice or fax signals extracted by the multiplexer.

There is further provided in accordance with an embodiment of the present invention, a method of operating a gateway to one or more packet based networks, comprising receiving signals over a same modem connection, separating the received signals to at least a first group and a second group, applying to the signals of the first group at least one processing task not applied to the second group, and transmitting the signals of the first and second groups on to one or more packet based networks. Optionally, the first group of signals comprises one or more of voice or fax signals. Optionally, applying to the signals of the first group at least one processing task not applied to the second group comprises one or more of decoding the voice signals or demultiplexing the fax signals. Optionally, applying to the signals of the first group at least one processing task not applied to the second group comprises adding at least one protocol header to packets including the signals of the first group.

In some embodiments of the invention, transmitting the signals of the first and second groups on to one or more packet based networks comprises transmitting the signals of the first and second groups on a same packet based network or transmitting the signals of the first group on a different packet based network than the signals of the second group.

Optionally, receiving signals over a modem connection comprises receiving signals over a voice band modem connection. Optionally, separating the received signals to at least a first group and a second group comprises separating to at least three groups, the signals of the third group being transmitted on to a switched network. Optionally, the second group of signals comprises data packets.

There is further provided in accordance with an embodiment of the present invention, a method of operating a gateway to one or more packet based networks, comprising receiving signals over a same modem connection, separating the received signals into at least a first group of fax signals and a second group of data signals, applying to the signals of the first group at least one processing task not applied to the second group, and transmitting the signals of the first and second groups on to one or more networks.

Optionally, receiving signals over a modem connection comprises receiving signals over a voice band modem connection. Optionally, the second group includes at least some fax signals handled the same way as data signals. Optionally, applying to the signals of the first group at least one processing task not applied to the second group comprises adding at least one header. Optionally, adding the at least one header comprises adding a TCP or UDP header.

Optionally, transmitting the signals of the first and second groups on to one or more networks comprises transmitting the signals of the first group on to a switched network and the signals of the second group on to a packet based network. Alternatively, transmitting the signals of the first and second groups on to one or more networks comprises transmitting the signals of the first and second groups on to one or more packet based networks.

There is further provided in accordance with an embodiment of the present invention, a method of transmitting communication signals, comprising providing a voice band modem connection between a user location and a gateway, establishing a plurality of telephone and/or fax calls between the user location and one or more remote locations, and transmitting, substantially concurrently, voice and/or fax signals of the plurality of established calls on the voice band modem connection.

Possibly, the method includes transmitting data packets on the modem connection, substantially concurrently with the voice and/or fax signals. Optionally, the modem connection has an uplink rate of up to 33,600 bps. Optionally, the one or more remote locations comprise at least two different locations. Optionally, the telephone and/or fax signals of at least two of the calls are transmitted from the gateway to their respective remote locations over different networks. Optionally, transmitting voice and/or fax signals of the plurality of established calls on the voice band modem connection comprises transmitting signals of at least one of the calls without one or more of standard VoIP or FoIP headers.

There is further provided in accordance with an embodiment of the present invention, a method of transmitting voice signals on a modem connection, comprising establishing a modem connection, receiving voice signals of a telephone call, selecting an encoding method, from a plurality of different voice encoding methods, for encoding the received voice signals, responsive to an estimate of the signals to be transmitted on the modem connection, encoding the received voice signals according to the selected method, and transmitting the encoded voice signals on the established modem connection.

Optionally, selecting the encoding method responsive to the estimate of the signals to be transmitted on the modem connection comprises selecting responsive to an estimate of available bandwidth on the modem connection. Optionally, selecting the encoding method responsive to the estimate of the signals to be transmitted on the modem connection comprises selecting responsive to a number of telephone, fax or both telephone and fax calls passing on the modem connection. Optionally, selecting the encoding method responsive to the estimate of the signals to be transmitted on the modem connection comprises selecting responsive to a quality of service assigned to at least one telephone or fax call passing on the modem connection.

Optionally, the modem connection carries signals of a plurality of telephone calls whose voice signals are encoded using different encoding methods. Possibly, the method includes changing the selected encoding method of the call without disconnecting the call. Optionally, the different encoding methods differ in their bandwidth requirements.

There is further provided in accordance with an embodiment of the present invention, a method of transmitting voice signals on a two way telephone call, through at least one gateway, comprising transmitting voice signals in a first direction over a first path in an encoded form and over a second path in a decoded form and transmitting voice signals in a second direction, opposite the first direction, over a third path in an encoded form and over a fourth path in a decoded form, wherein the first and third paths do not overlap.

There is further provided in accordance with an embodiment of the present invention, a communication system, comprising at least one general purpose computer adapted to generate signals for transmission, and a voice band modem adapted to establish a modem connection with a remote modem and to transmit the signals generated by the at least one general purpose computer over the modem connection, wherein the voice band modem establishes the modem connection without receiving instructions from the general purpose computer to establish the connection.

Optionally, the system includes at least one telephone or fax machine adapted to generate signals for transmission over the modem connection. Optionally, the voice band modem is configured to establish the modem connection whenever the modem is powered and the connection is not operative. Optionally, the voice band modem comprises a user control which when actuated initiates the establishment of the modem connection. Alternatively or additionally, the voice band modem is configured to establish the modem connection according to a predetermined time scheme. Optionally, the voice band modem comprises an internal storage which stores at least one parameter used in establishing the modem connection. Optionally, the at least one parameter used in establishing the modem connection comprises at least one of a username, a password and a telephone number to be dialed in establishing the connection. Optionally, the at least one parameter stored in the internal storage may be changed by the general purpose computer.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a combined telephone, fax and data communication connection, in accordance with an embodiment of the present invention;

FIG. 2 is a schematic block diagram of a subscriber system with a combined modem gateway, in accordance with an embodiment of the present invention;

FIG. 3 is a schematic block diagram of a logical server of a RAS, in accordance with an embodiment of the present invention;

FIG. 4 is a flowchart of the acts performed in establishing a telephone call from a subscriber system, in accordance with an embodiment of the present invention;

FIG. 5 is a flowchart of the acts performed in establishing a telephone call directed to a subscriber system, in accordance with an embodiment of the present invention; and

FIG. 6 is a schematic illustration of a FoIP and VoIP hybrid processing path, in accordance with an embodiment of the present invention.

### DETAILED DESCRIPTION OF EMBODIMENTS

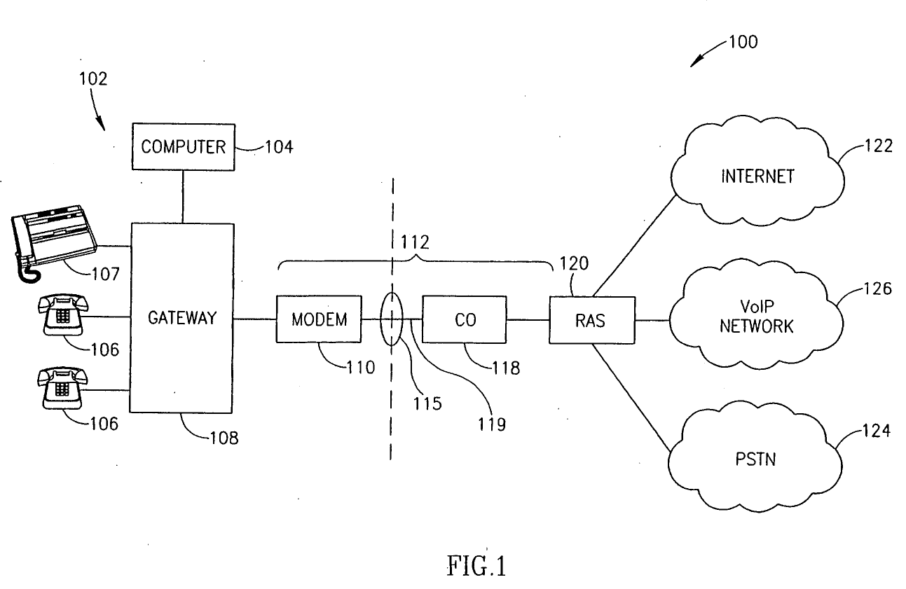

FIG. 1 is a schematic illustration of a combined telephone, fax and data communication connection 100, in accordance with an embodiment of the present invention. A subscriber system 102 comprises at least one computer 104, which transmits and receives data signals, one or more telephone sets 106, which transmit and receive voice signals and one or more fax machines 107. A subscriber modem 110 connects subscriber system 102 to a remote access server (RAS) 120, over a modem connection. In some embodiments of the invention, the modem connection comprises a voice band modem (VBM) connection or an ISDN connection, passing on a standard switched network segment 112, for example of a PSTN. The standard switched network 112 optionally interfaces to subscriber system 102 through an analog PSTN interface 115. RAS 120 serves as a gateway to a packet based network, such as the Internet 122, for data packets transmitted from computer 104. Additionally or alternatively, RAS 120 serves as a gateway to at least one voice network, such as the PSTN 124 and/or a VoIP network 126. In some embodiments of the invention, the Internet 122 may also serve as a voice network.

In some embodiments of the invention, modem 110 is controlled by computer 104, i.e., instructions to establish a modem connection and parameters of the connection, e.g., a telephone number to dial, a user name and/or a password, are provided by computer 104. Alternatively or additionally, modem 110 may operate without control of computer 104. In some embodiments of the invention, modem 110 is configured with parameters required in establishing a connection. Optionally, modem 110 is configured with instructions on when to establish a connection and/or when to disconnect the connection. For example, in some embodiments of the invention, modem 110 is configured to establish a connection whenever it receives power and to keep the connection active as long as the modem is powered. Alternatively or additionally, modem 110 is configured to establish the modem connection in the morning and disconnect in the evening. Further alternatively or additionally, modem 110 is configured to establish the modem connection when a telephone 106 is lifted off-hook and the modem connection is not operating. Optionally, modem 110 is configured by a user interface on computer 104. Alternatively or additionally, modem 110 includes a button or other user interface, through which a user may instruct the modem to establish a connection.

It is noted that the invention may be implemented without fax machine 107, without telephones 106, or with more than one fax machine 107. In addition, computer 104 may serve as a fax machine. Furthermore, the invention may be implemented without computer 104, which as described above, is not essential to control modem 110.

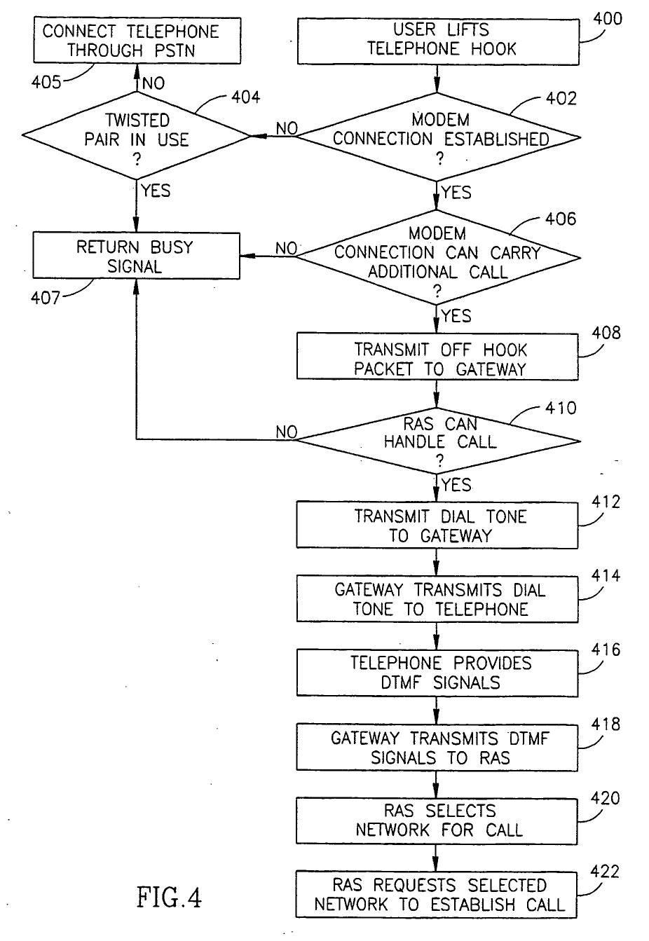

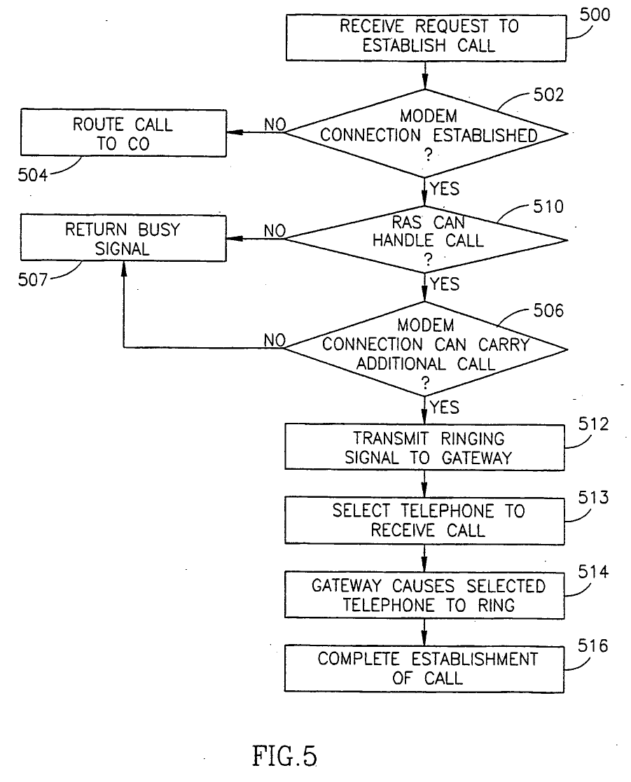

Optionally, the modem connection comprises a standard modem connection, such as, a VBM modem connection as defined, for example, by the V.34, V.90, V.91 or V.92 ITU recommendations. Alternatively, any other modem connections may be used. The modem connection passing on network segment 112 carries data packets from/to computer 104, voice packets from/to telephones 106 and/or fax packets from/to fax machine 107. When the modem connection between modem 110 and RAS 120 is established, telephone calls and/or fax calls directed to subscriber system 102 are optionally routed through RAS 120 over the modem connection to subscriber system 102. Likewise, telephone and/or fax calls initiated from telephones 106 and/or fax machine 107, while the modem connection is operative, are directed through RAS 120 to remote telephones and/or faxes, over the PSTN 124, Internet 122 and/or VoIP network 126. Exemplary methods of establishment and termination of telephone and fax calls is described hereinbelow with reference to FIGS. 4 and 5. It is noted, however, that other telephone and fax call establishment methods may be used, such as described in the above mentioned U.S. Pat. Nos. 5,870,465, 5,764,639 and/or 5,889,845.

A gateway 108 optionally couples computer 104, fax machines 107 and telephones 106 to modem 110. In some embodiments of the invention, gateway 108 and modem 110 are implemented as separate units. Alternatively, gateway 108 and modem 110 are implemented as a single combined unit.

In some embodiments of the invention, when the modem connection is not established, (e.g., due to power cut off, modem failure, RAS failure or due to a user choice) one of telephones 106 and/or fax machine 107, connected through gateway 108 to network segment 112 may be used with the PSTN through analog interface 115, using standard switched telephone methods. Optionally, when modem 110 is not operating, one or more of telephones 106 and/or fax machine 107 are connected in parallel, over a by-pass line (by-passing gateway 108) to analog interface 115. Alternatively, the one or more of telephones 106 and/or fax machine 107 are connected through a telephone switch, which passes the signals from analog interface 115 only to one or more of telephones 106 and/or fax machine 107, when modem 110 is not operating. Alternatively, when the modem connection is not established, the telephone line between subscriber system 102 and CO 118 (e.g., a twisted pair segment 119) may be used by a different telephone (not shown) not connected to gateway 108.

In some embodiments of the invention, RAS 120 may be located at substantially any point relative to subscriber modem 110. Particularly, switched network segment 112, connecting RAS 120 to subscriber modem 110, may include one or more standard PSTN switches, such as a central office (CO) 118. Alternatively to connecting RAS 120 to subscriber modem 110 over a VBM or ISDN connection, RAS 120 is connected to subscriber modem 110 through a DSL connection, and/or any other modem connection. In some embodiments of the invention, RAS 120 is located at the CO 118 servicing subscriber system 102. For some modem connections, e.g., DSL connections, positioning RAS 120 at CO 118 may be required.

The following description describes the transmission of signals in the uplink direction (i.e., from subscriber system 102 to RAS 120) in detail. The downlink direction is generally the inverse of the uplink and will be understood therefrom. The downlink is generally mentioned only when considered necessary for clarity.

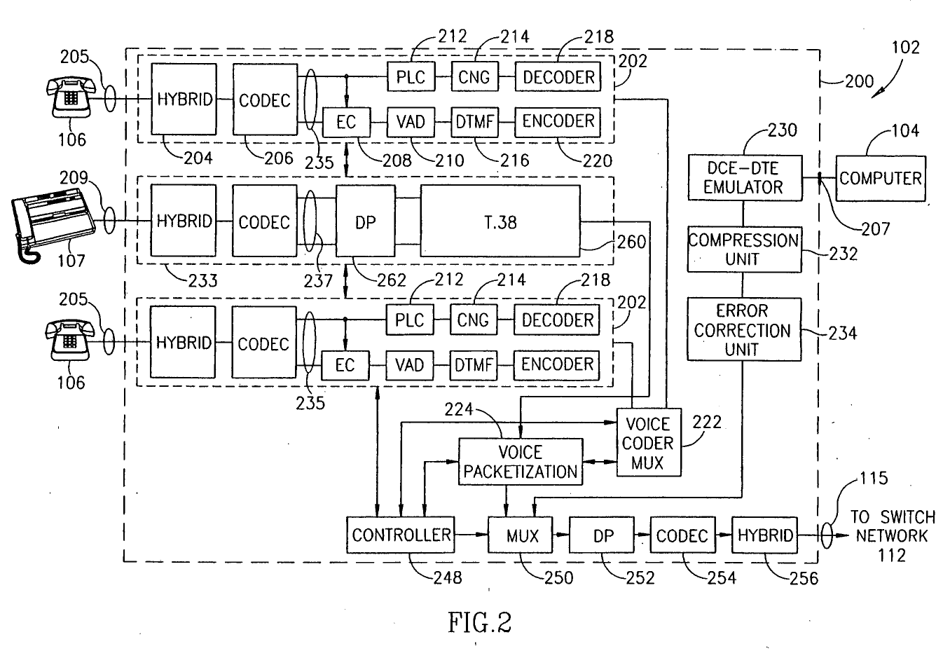

FIG. 2 is a schematic block diagram of subscriber system 102 with a combined modem gateway 200 (performing the tasks of both gateway 108 and modem 110 in FIG. 1), in accordance with an embodiment of the present invention. Gateway 200 optionally includes a data interface 207, e.g., a RS-232 interface, a USB (universal serial bus) interface or a RJ-45, which connects to computer 104. In addition, gateway 200 includes a plurality of telephone analog interfaces 205 which connect to telephones 106, and a fax analog interface 209 which connects to fax machine 107. Gateway 200 further comprises an outlet which connects to analog interface 115.

In some embodiments of the invention, for each telephone 106, gateway 200 comprises a signal conversion path 202, which converts analog voice signals into compressed digital voice signals and vice versa. In some embodiments of the invention, signal conversion path 202 comprises a hybrid unit 204, a codec 206, an echo canceller (EC) 208, a voice activity detection (VAD) unit 210, a PLC 212, a CNG 214, a dual tone multi-frequency (DTMF) unit and/or a tone detector 216, a decoder 218 and an encoder 220, as is known in the art. The elements of signal conversion path 202 may be implemented in hardware, software or a combination thereof. In an exemplary embodiment of the invention, the elements of one or more signal conversion paths 202 are implemented on a single digital signal processor (DSP). Other configurations may be used for signal conversion path 202, to convert telephone signals into encoded voice signals for transmission over the modem connection.

For each fax machine 207, gateway 200 optionally includes a fax conversion path 233, which converts analog fax signals into encoded fax signals, for example in accordance with the T. 38 protocol. Optionally, fax conversion path 233 comprises a hybrid unit 204, a codec 206, a data pump (DP) 262 and a T.38 unit 260. T.38 unit 260 inserts demultiplexed fax signals from DP 262 into T.38 messages, e.g., Internet facsimile protocol (IFP) packets.

Alternatively or additionally to analog interfaces 205 and/or 209, gateway 200 includes one or more digital telephone interfaces 235, which connect to digital telephones and/or one or more digital fax interfaces 237. In some embodiments of the invention, digital interfaces 235 and/or 237 connect to a conversion path 202 or 233, respectively-, bypassing hybrid 204 and/or 206. Alternatively or additionally, gateway 200 comprises one or more separate digital interface conversion paths.

Alternatively to including a conversion path 202 for each analog interface 205 (telephone 106), gateway 200 includes a predetermined number of conversion paths 202 according to a maximal capacity of voice and fax channels on network segment 112. Optionally, in this alternative, gateway 200 includes a telephone switch which connects conversion paths 202 to analog interfaces 205, according to telephone switching conventions known in the art.

Further alternatively or additionally, each analog interface 205 includes respective hybrid units 204 and codecs 206. Gateway 200 includes a predetermined number of digital conversion paths which optionally include all the elements of paths 202, except hybrid unit 204 and codec 206. A digital switch optionally dynamically connects the digital conversion paths to the analog interfaces 205 and/or to one or more digital interfaces.

In some embodiments of the invention, analog fax interface 209 is also connected through an analog or digital switch with analog interfaces 205. Alternatively, analog fax interface 209 is connected through an independent conversion path. Further alternatively, gateway 200 includes dual purpose conversion paths which are capable of performing both voice and fax conversions. The specific task performed by the conversion path is optionally determined according to the signals passing therethrough and/or the apparatus (e.g., telephone or fax) to which they are connected.

The maximal capacity of voice and fax channels on network segment 112 may be defined according to the data rate of the modem connection on network segment 112 and/or responsive to a maximal number of voice and/or fax channels desired by the user.

Optionally, analog voice signals from telephones 106 are converted into digital signals by codec 206 and are encoded by encoder 220. The encoded signals from encoders 220 servicing active telephone calls, are provided to a voice coder, multiplexer 222, which combines the encoded signals. Optionally, at predetermined intervals, for example every 10 ms, each operative encoder 220 provides multiplexer 222 with a voice sample of a predetermined size, e.g., for the G.729 protocol 10 bytes. In some embodiments of the invention, when a telephone call includes a silence sample, encoder 220 does not provide multiplexer 222 with a sample for the silence period. Alternatively or additionally, multiplexer 222 discards samples of silence periods. Further alternatively or additionally, some silence period samples are transmitted on the modem connection.

In an exemplary embodiment of the invention, multiplexer 222 packs the voice samples it receives into a combined frame, which carries all the voice samples received at a specific time. Optionally, the frame includes a header that indicates for which telephone calls the frame includes voice samples. In an exemplary embodiment of the invention, the frame has the following format:

| | | |
|---|---|---|
| ID | dₙ, . . . , d₂, d₁, d₀ | data samples of channels |

in which ID, is a code that designates that the frame is a voice frame, and dₙ, . . . ,d₂,d₁ are bits which designate for each of a plurality (n) of channels whether the frame carries data for that channel. Optionally, a payload section of the frame includes the received voice samples in a predetermined order. In some embodiments of the invention, the voice samples are placed in the payload of the frame in the same order as bits dₙ, . . . ,d₂,d₁, are positioned, noting that for some of the channels there may not be a respective sample. It is noted that the frames have different lengths, according to the number of channels from which samples were provided for the specific frame.

In some embodiments of the invention, the n channels for which {dᵢ} bits are placed in the frame comprise channels currently carrying active telephone calls. Alternatively, the n channels for which {dᵢ} bits are placed in the frame comprise channels currently carrying active telephone or fax calls. When a new call is established and when a call is terminated, gateway 200 and RAS 120 adjust accordingly the number of bits {dᵢ} in the frames and the calls corresponding to each bit dᵢ.

Further alternatively, the n channels for which {dᵢ} bits are placed in the frame comprise a predetermined maximal number of telephone or fax calls which may pass on the modem connection. In some embodiments of the invention, the predetermined maximal number of telephone or fax calls is set according to a predetermined maximal number of calls desired by the subscriber and/or according to the capacity of the modem connection between modem 110 and RAS 120 and the bandwidth requirements of the calls.

In an exemplary embodiment of the invention, ID is a four bit field, that has a specific value for voice frames, e.g., ‘1101’.

Alternatively to combining all the samples received from different telephone calls at a single time into a single frame, the samples from one or more encoders 220 are placed in a separate frame. Instead of bits {dᵢ}, such frame may indicate an ID of the channel to which the sample in the frame belongs. This alternative simplifies gateway 200, but increases the bandwidth requirements of calls on the modem connection.

In some embodiments of the invention, as described above, the analog signals from fax 107, are digitized by codec 206, demultiplexed by DP 262 and converted into IFP packets by T.38 unit 260. T.38 unit 260 optionally also generates IFP packets that include control frames, as is known in the art. Alternatively or additionally, fax conversion path 233 receives demultiplexed samples from fax 107 and the packets are provided directly to T.38 unit 260. Optionally, the IFP packets from all of faxes 107 used concurrently, if a plurality of faxes are used concurrently, are placed in a single frame, for example, using a scheme similar to that described above for voice samples. Alternatively, the IFP packets of each fax machine 107 are placed in separate frames. Optionally, the fax frames have a specific value for ID, e.g., 1011. In some embodiments of the invention, the fax frames include an indication of the length of the IFP packets. Alternatively, the IFP packets are provided with a fixed length.

Further alternatively, the IFP packets are combined with the voice samples in a single frame. Optionally, controllers of gateway 200 and RAS 120 keep track for each channel whether the channel carries voice samples or IFP packets.

In some embodiments of the invention, T.38 unit 260 provides fax signals at a predetermined rate which is a function of the transmission rate of the fax call. Alternatively or additionally, for example when a retransmission method is used for the fax call, the rate of providing fax signals is lower than the transmission rate of the fax call, and is increased whenever the modem connection has free bandwidth, e.g., is transmitting idle flags. In some embodiments of the invention, the rate at which T.38 unit 260 provides fax signals is a function of the available bandwidth on the modem connection and/or of the number of telephone and/or fax calls passing on the modem connection.

Optionally, T.38 unit 260 periodically provides fax samples which include a predetermined number of bytes of data. Changing the fax signal rate is optionally performed by changing the rate at which fax samples are provided and/or the number of bytes in each provided fax sample. In some embodiments of the invention, the fax samples are provided at the same rate as voice samples, e.g., every 10 msec. Alternatively or additionally, the fax samples have the same length (e.g., the same number of bytes) as voice samples.

Optionally, gateway 200 includes a controller 248 which establishes and/or manages the telephone and/or fax calls. Optionally, controller 248 also controls conversion paths 202. In some embodiments of the invention, controller 248 additionally controls a home telephone exchange, which services telephones 106 and fax machine 107.

In some embodiments of the invention, controller 248 exchanges voice and/or fax control frames with a controller of RAS 120 in managing the telephone connections. The control frames may be used, for example, to convey signals such as active, inactive, off-hook, on hook, DTMF, VAD, ring and dial tone signals. Alternatively or additionally, other control frames may be defined.

In some embodiments of the invention, the combined frames from multiplexer 222, the frames from T.38 unit 260 and the control frames generated by controller 248 are forwarded to a voice and fax packetization unit 224 which packs the frames into V.42-type packets. As defined in the V.42 recommendation, V.42 packets have the following structure:

| | | | | | |
|---|---|---|---|---|---|
| flag | address | control | Octet1 | data | CRC |

In some embodiments of the invention, the voice and/or control frames are placed in the data field and one or more voice identification sub-fields in the control and/or Octetl fields are used to differentiate between data packets from computer 104, voice and fax packets from voice and fax packetization unit 224 and voice and fax control packets from controller 248.

Alternatively or additionally to packetization unit 224 placing control frames in packets, controller 248 packetizes the control frames.

Data packets received from computer 104 are optionally passed through a data compression (DC) unit 232 (e.g., a V.42bis unit) and an error correction (EC) unit 234 (e.g., a V.42 unit), as is known in the art. Alternatively, the data packets are passed through a combined ECDC unit, or only through an EC unit.

Optionally, gateway 200 includes a data communication equipment—data terminal equipment (DCE-DTE) emulator 230, which serves as an interface between computer 104 and modem 110. In some embodiments of the invention, as described above, gateway 200 may operate even when computer 104 is not operating. Optionally, when computer 104 is activated when a connection between gateway 200 and RAS 120 is already active, DCE-DTE emulator 230 responds to modem control signals from computer 104 instead of gateway 200.

In some embodiments of the invention, the packets from packetization unit 224 and from error correction unit 234 are combined by a multiplexer 250. Optionally, multiplexer 250 comprises respective buffers for voice control packets, voice data packets, fax data packets, fax control packets and data packets. Alternatively, fewer or more buffers are used, for example, according to the number of types of packets having different priorities. In an exemplary embodiment of the invention, for example, a single buffer is used for fax and voice control packets. Multiplexer 250 optionally operates according to the V.70 protocol.

Optionally, multiplexer 250 transfers packets to a data pump (DP) 252 for transmission according to a predetermined priority scheme. In an exemplary embodiment of the invention, control packets are given a highest priority, voice data packets are given a second highest priority, fax packets are given a third highest priority and data packets are transmitted when no other packets for transmission are available. In another embodiment, fax signals are given higher priority than voice signals. Alternatively or additionally, the subscriber may adjust the priorities of the packets, for example using a user interface on computer 104. For example, when desired, the user may set a bandwidth amount in which data packets and/or fax packets are given highest priority. Further alternatively or additionally, other methods, than using a plurality of buffers, are used to impose the defined priorities.

Data pump 252 optionally transmits symbols representing the packets from data pump 252 on to switched network segment 112 through a codec 254 and a hybrid unit 256, as is known in the art.

Referring in more detail to the encoding and decoding performed by decoder 218 and encoder 220, in some embodiments of the invention, the encoding is performed according to a predetermined encoding scheme, such as the G.723 or the G.729 protocols. Alternatively or additionally, the user may select at installation and/or at any other time, an encoding scheme to be used by all the telephone connections. Further alternatively or additionally, at the beginning of each telephone connection, controller 248 negotiates (or notifies) the encoding scheme to be used with a remote gateway of the telephone connection. Optionally, at the establishment of the connection between modem 110 and RAS 120, and/or when otherwise desired by the user, the user defines rules which govern the encoding schemes to be used for specific telephone connections. It is noted that different telephones 106 of a single subscriber system 102 may use the same or different encoding schemes.

In some embodiments of the invention, the encoding scheme used for a specific connection is a function of the time of day at which the telephone connection is established. For example, during busy hours higher compression rates may be used than during low usage hours. Alternatively or additionally, the encoding scheme used for a specific connection is a function of the number of telephone connections with system 102 already active. For example, a first connection to be established may use a larger amount of bandwidth than a second or third connection, so as to limit the percentage of bandwidth of the connection on network segment 112 utilized by telephones 106. Further alternatively or additionally, the encoding scheme used for a specific connection is a function of the amount of data transmitted by computer 104 and/or a quality of service (QoS) defined for transmission of the data. Further alternatively or additionally, the encoding scheme used for a specific connection is a function of whether the telephone call was initiated by system 102 or by a remote telephone. Further alternatively or additionally, the user may define different encoding schemes for different telephones 106. For example, the user may define a work telephone with high QoS and low compression rate and a play telephone with a high compression rate. In another example, different compression rates may be used for analog and digital telephones. Further alternatively or additionally, the compression rate is adjusted responsive to the round trip delay of signals to the remote gateway or telephone, for example when the signals are transmitted on VoIP network 126. It is noted, however, that the effect of the compression rate on the load of VoIP network 126 is relatively low, as the VoIP headers take up most of the bandwidth of the transmitted signals.

In some embodiments of the invention, the same encoding scheme is used in both directions of the telephone connection. Alternatively, different encoding schemes may be used for the different transmission directions (uplink and downlink) of the same telephone call. In some embodiments of the invention, the uplink may use a lower compression rate, for example, when the data transmission requires mainly downlink bandwidth. The use of different uplink and downlink encoding methods also allows finer adjustment of the power consumption of the encoding and of the bandwidth consumption of the telephone signals on the modem connection.

In some embodiments of the invention, the encoding scheme defined for a specific telephone connection is used throughout the entire connection. Alternatively, the encoding scheme may be changed during the progress of the connection. For example, when another telephone connection is established and/or a large flow of data packets is received from computer 104, the encoding scheme is changed so that the telephone connection utilizes less bandwidth. Conversely, when a telephone connection is terminated and/or the amount of data packets transmitted by computer 104 is reduced, the encoding scheme may be changed to a higher bandwidth scheme which provides better voice quality.

As described above, RAS 120 does not decode the voice samples it receives, but rather converts them into standard VoIP packets and transmits them to a remote gateway, i.e., a gateway near the destination of the telephone call. Thus, RAS 120 does not require the additional processing power required for encoding and decoding. Alternatively or additionally, for some connections and/or at specific times, RAS 120 decodes the voice samples it receives from subscriber system 102. The decoded samples are optionally re-encoded using a different encoding method. Thus, Subscriber system 102 can operate with remote gateways, even if they do not support a shared encoding method, or can support use of different encoding methods for the uplink and downlink even if the remote gateway does not support such a feature. Alternatively, the decoded signals are transmitted non-encoded from RAS 120 to the remote gateway. This alternative may be used, for example, to reduce the processing load on the remote gateway. Optionally, at the establishment of a telephone connection, RAS 120 and the remote gateway determine which of them is to perform the decoding and/or encoding, for example according to the processing load on the RAS and/or the remote gateway. Optionally, one of RAS 120 and the remote gateway perform the encoding and the other performs the decoding.

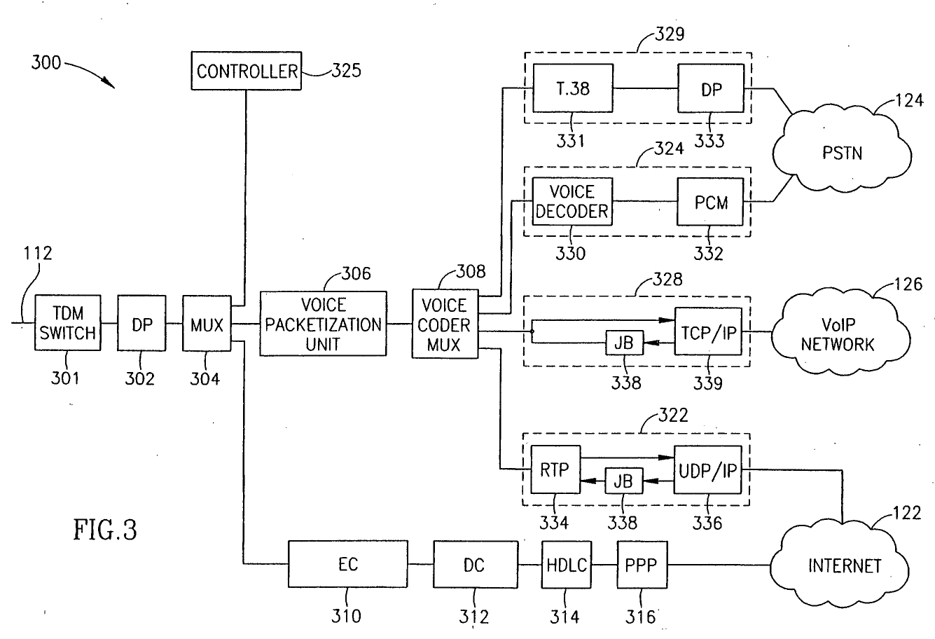

FIG. 3 is a schematic block diagram of a portion of RAS 120, referred to herein as a logical server 300, in accordance with an embodiment of the present invention. Server 300 is optionally a dynamically assigned portion of RAS 120, which is assigned for handling signals from a single subscriber system 102. RAS 120 optionally comprises a plurality of data pumps DP 302 (only one DP is shown) which form respective modem connections with subscriber systems 102. A TDM switch 301 optionally connects switched network segments 112, currently carrying modem connections, to DPs 302. A controller 325 of RAS 120 optionally defines for each modem connection that is to pass telephone and/or fax calls according to the present invention, a logical server 300 which includes processing paths required for the active elements of the respective subscriber system 102.

In some embodiments of the invention, RAS 120 comprises an array of voice processing paths 322, which process voice signals to be forwarded on the Internet 122 and/or on VoIP network 326, an array of voice PSTN processing paths 324, which process voice signals to be forwarded on PSTN 124, arrays of fax processing paths 328, which process fax signals forwarded on packet based networks and an array of fax PSTN processing paths 329, which process fax signals to be forwarded on PSTN 124. For clarity, FIG. 3 shows only one of each of processing paths 322, 324, 328 and 329, which are currently assigned to a specific subscriber system 102.

In the example of FIG. 3, the subscriber system 102 is connected to two faxes, one over PSTN 124 and one over VoIP network 126, and to two telephones one over PSTN 124 and one over Internet 122. A controller of RAS 120, e.g., controller 325, optionally assigns processing paths from the arrays to logical server 300, according to the communication needs of the subscriber, as described hereinbelow with reference to FIGS. 4 and 5.

Server 300 comprises a data pump 302 which converts the analog symbols from switched network segment 112 into V.42-type packets, as is known in the art. A multiplexer 304, e.g., a V.70 multiplexer, examines the packets, e.g., the contents of the voice identification sub-fields of the packets, to determine the type (e.g., voice or fax control, voice or fax data, data) of the packet. Multiplexer 304 optionally forwards control packets to a controller 325, voice and fax data packets to a packetization unit 306 and data packets to an EC unit 310, corresponding to EC unit 234 of combined modem gateway 200 (FIG. 2). Alternatively or additionally, the control packets are passed through packetization unit 306, which forwards the packets after de-packetization to controller 325.

In some embodiments of the invention, the signals passed to EC unit 310 are handled by EC unit 310 and are then optionally passed through a DC unit 312, an HDLC unit 314 and a PPP unit 316, as is known in the art. Alternatively, the signals may be transmitted, without performing complete modem termination, to a remote gateway, which completes the modem termination or reconverts them to modem signals, as described in PCT application PCT/IL01/00531, filed Jun. 11, 2001 or in PCT application PCT/IL01/00455 filed May 21, 2001, the disclosure of which is incorporated herein by reference. For example, the signals from EC unit 310 or the data packets from multiplexer 304 may be transmitted directly onto the Internet 122.

Further alternatively or additionally, the data packets may be transmitted on to a packet based network other than the Internet 122, or may be transmitted on to a modem connection.

Packetization unit 306 optionally de-packetizes the packets it receives and forwards voice frames to a voice coder multiplexer 308, and fax frames directly to pre-assigned fax processing paths 328 and/or 329 allocated to corresponding fax conversion paths 233 (FIG. 2). Alternatively, voice coder multiplexer 308 receives also fax frames and passes fax samples to corresponding processing paths 328 and/or 329. Voice coder multiplexer 308 optionally distributes the voice signals from each signal conversion path 202 (FIG. 2) to a respective voice processing path (322 or 324). In some embodiments of the invention, multiplexer 308 examines the header of the voice frames it receives, to determine to which processing path to forward the voice samples in the frame. As described above, the number of processing paths assigned to logical server 300 depends on the number of currently established telephone and fax calls.

In some embodiments of the invention, each of voice PSTN paths 324 comprises a voice decoder 330 and a PCM unit 332, as is known in the art. Fax PSTN path 329 optionally comprises a T.38 unit 331, which removes the T.38 encapsulation added to fax signals by subscriber system 102, and a data pump (DP) 333 which modulates the fax samples for transmission on PSTN 124. T.38 unit 331 optionally provides downlink fax samples according to any of the schemes described above regarding T.38 unit 260. Units 331 and 260 may use for a specific connection the same schemes or different schemes.

Controller 325 optionally receives the voice and fax control packets from subscriber system 102 and accordingly responds as described below with reference to FIGS. 4 and 5. It is noted that some of the control packets may be forwarded to a remote gateway, optionally after suitable format conversion.

Voice processing paths 322 optionally receive compressed voice samples as they were provided by encoder 220, after their packetization (performed by subscriber system 102) was removed by voice packetization unit 306 and/or multiplexer 308. Voice processing paths 322 pass the compressed voice samples through an RTP unit 334 which adds an RTP header, as is known in the art, to the samples. The samples with the RTP header are then passed through a UDP/IP unit 336 which adds UDP and IP headers to the samples, thus providing standard VoIP packets.

Fax processing paths 328 optionally receive IFP packets as they were provided by T.38 unit 260, after their packetization (performed by subscriber system 102) was removed by voice packetization unit 306 and/or multiplexer 308. Fax processing paths 328 optionally pass the processing packets through a TCP/IP unit 339 which adds TCP and IP headers to the IFP packets, producing standard FoIP packets. Alternatively to adding TCP and IP headers to the IFP packets, UDPTL, UDP and IP headers are added to the IFP packets, as is known in the art.

The standard VoIP and/or FoIP packets from processing paths 322 and 328 are forwarded on to a packet based network, e.g., Internet 122 or VoIP network 126, which leads the packets to their destination. It is noted that the added headers provide addressing information, which allows transmission of the packets on an addressable packet based network, which connects more than two end units.

In some embodiments of the invention, each processing path 322 comprises a separate UDP/IP unit 336 and each fax processing path 328 comprises a separate TCP/IP unit 339. Alternatively or additionally, a plurality of processing paths 322 include a single UDP/IP unit 336 and/or a plurality of processing paths 328 include a single TCP/IP unit 339.

In some embodiments of the invention, downlink packets passing through processing paths 322 and 328 are passed through a jitter buffer (JB) 338, which regulates the voice or fax signals received from VoIP network 126 or Internet 122, as is known in the art. Jitter buffer 338 of fax path 328 optionally provides fax samples in accordance with any of the schemes described above for T.38 unit 331.

In some embodiments of the invention, at the establishment of a telephone or fax call, RAS 120 allocates a processing path (322, 324, 328 or 329) to the connection and connects the processing path to the network (122, 124 or 126) on which the signals are to pass. Alternatively or additionally, different processing paths 322 and/or 328 are allocated for different networks 122 and 126, and when a call is established, a processing path connected to the required network is used.

In some embodiments of the invention, all of processing paths 322 are substantially identical. Alternatively, processing paths 322 connected to different networks, e.g., 122 or 126, and/or servicing different QoS calls, are different. For example, the processing paths may differ in the settings of their jitter buffers 338.

It is noted that the types of processing paths 322, 324, 328 and 329 are described by way of example and fewer or additional types of processing paths may be used. For example, RAS 120 may include only fax processing paths or only voice processing paths and/or may include only processing paths for switched networks and/or only for packet based networks. In addition, RAS 120 may include additional processing paths, which connect to additional-types of networks, such as ATM networks, satellite networks and/or cellular networks.

It is noted that the elements of processing paths 322, 324, 328- and 329 may be implemented using software, hardware or a combination of software and hardware. In some embodiments of the invention, instead of using different processing paths for different types (e.g., telephone, fax) of calls and/or for different networks, RAS 120 includes a single type of path which performs all the required processing tasks. Controller 325 adjusts the operation of the paths according to the type of the call passing on the path and the network being used.

The task of preparation of VoIP and FoIP packets for transmission to a remote gateway is thus distributed between gateway 108 in subscriber system 102 and processing paths 322 or 328 of RAS 120. The distribution of the gateways tasks allows on the one hand using standard large bandwidth VoIP and FoIP packets while limiting the bandwidth consumption of the telephone and fax calls on the modem connection between RAS 120 and subscriber system 102.

In an exemplary embodiment of the invention, signal conversion path 202 (FIG. 2) operates in accordance with the G.729 vocoder and hence provides 10-byte samples every 10 msec. For three telephone calls, voice multiplexer 222 receives up to 30-bytes every 10 msec. The telephone call identification bits and V.42 packet fields added by voice multiplexer 222 and/or packetization unit 224 add up to about 5 bytes, every 10 msec. Thus, each second, packetization unit 224 provides up to 3,500 bytes of voice data packets, which is equivalent to a bit rate of 28,000 bits/second (there are 8 bits in each byte). If the modem connection is in accordance with the V.34 ITU recommendation, its bit rate is up to 33,600 bits/second, leaving at least 5,600 bps for data from computer 104. It is noted that at any time one or more of the telephone calls may be silent, for example, the user may be listening silently to a remote party, so that the data rate remaining for computer 104 is generally greater on the average.

In some embodiments of the invention, processing paths 322 add to the samples of a single telephone call (including 10 bytes) an RTP header including 12 bytes, a UDP header including 8 bytes and an IP header including 20 bytes. Thus, the data rate transmitted over VoIP network 326 for a single telephone call is up to 40,000 bps, more than can pass on a V.34 modem connection.

Alternatively to the modem connection between RAS 120 and modem 110 comprising a VBM connection, the modem connection may comprise an ISDN connection. In this alternative, data pump 302 of server 300 is optionally replaced by a V.120 or HDLC unit. Alternatively or additionally, EC and/or DC units 310 and 312 or optionally omitted or replaced by an ISDN-equivalent unit. Similarly, in FIG. 2, EC and/or DC units 234 and 232 are optionally omitted and data pump 252, codec 254 and hybrid 256 are optionally replaced by a V.120 or HDLC unit and a low layer ISDN unit.

Further alternatively or additionally, RAS 120 and subscriber system 102 may be connected through a plurality of modem connections which are used as a single connection using line bonding (unification) methods known in the art. Thus, the number of telephone and/or fax calls passing between RAS 120 and subscriber system 102 can be larger than if the each modem connection is used separately.

In some embodiments of the invention, RAS 120 can service, also regular clients, which require only data services. A DP assigned to such clients is optionally connected directly to an EC 310. Alternatively or additionally, the DP 302 is connected to a multiplexer (mux) 304 which passes all the signals received from DP 302 to EC 310. Optionally, clients requiring telephone and/or fax call services, as described above, have different service agreements from the service agreements of clients requiring only data services. Alternatively or additionally, all clients have substantially the same service agreements and differ only in the actual usage and/or in the apparatus included in subscriber system 102.

FIG. 4 is a flowchart of the acts performed in establishing a telephone call from subscriber system 102, in accordance with an embodiment of the present invention. When a user desires to establish a telephone call, the user lifts (400) one of telephones 106 off its hook. If (402) the modem connection between modem 110 and RAS 120 is not established, and twisted pair segment 119 is not in use (404), gateway 108 optionally connects (405) the lifted telephone 106 to the PSTN over twisted pair segment 119 using standard switched telephone methods. If (404) twisted pair segment 119 is in use, a busy signal is optionally returned (407) by gateway 108. If (402) the modem connection between modem 110 and RAS 120 is established, gateway 108 optionally determines (406) whether the modem connection may carry an additional telephone call. If (406) the modem connection cannot carry an additional telephone call, a busy signal is optionally returned (407) to the lifted telephone 106.

If (406) the modem connection can carry an additional telephone call, gateway 108 transmits (408) an off-hook control packet to RAS 120. If (410) RAS 120 can service the telephone call, RAS 120 transmits (412) to gateway 108 a dial tone control signal. If (410), however, RAS 120 cannot handle the call, a busy signal is optionally returned (407) to gateway 108. Responsive to the dial tone signal, gateway 108 transmits (414) a dial tone to the lifted telephone 106. The telephone responds (416) with DTMF signals, as is known in the art, and gateway 108 forwards (418) respective DTMF control packets to RAS 120. When RAS 120 accumulates DTMF signals of a telephone number, RAS 120 selects (420) a network (PSTN 124, Internet 122, VoIP network 126) over which the call is to pass. Alternatively, gateway 108 determines which network is to carry the call (optionally, based on a user instruction) and a control packet stating the selected network is transmitted to RAS 120.

RAS 120 then requests (422) establishment of a connection from a remote gateway, on the selected network. Optionally, if the selected network comprises VoIP network 126 or Internet 122, the request is performed by a media gateway-controller (MGC) operating above RAS 120. Optionally, RAS 120 keeps track of legal telephone number rules, so as to allow identification of the dialed telephone numbers. Alternatively, gateway 108 identifies the dialed telephone number and transmits the entire number to RAS 120 in a voice control packet.

Referring in more detail to determining (406) whether the modem connection may carry an additional telephone call, in some embodiments of the invention, the determination includes determining the number of currently established telephone calls on the modem connection. In addition, the determining (406) of whether the modem connection may carry an additional telephone call, optionally includes determining the current bandwidth of the modem connection between RAS 120 and modem 110. It is noted that the bandwidth of the modem connection may change according to transient noise levels. Responsive to the current bandwidth of the modem connection and compression rates of the current telephone calls, a maximal number of telephone calls which may pass on the modem connection is determined. The maximal number of telephone calls may take into account a minimal desired data rate for packets from computer 104 and/or an overbooking rate of telephone calls.

In some embodiments of the invention, determining (406) whether the modem connection may carry an additional telephone call depends on the time, date and/or on the specific telephone 106 used. For example, certain telephones 106 may have higher priorities than other telephones.

In some embodiments of the invention, the determination (406) whether the modem connection may carry an additional telephone call, includes determining a compression rate at which the requested telephone call is to operate. In some embodiments of the invention, the compression rate is a function of the time, date and/or a priority of the telephone 106 used and/or of the user of the telephone.

In an exemplary embodiment of the invention, a first telephone call passing on the modem connection operates with a relatively low compression rate, i.e., with a resultant relatively high bandwidth, while subsequent telephone calls use higher compression rates. Optionally, when necessary, existent telephone calls are moved to higher compression rates in order to make room for the requested telephone call. Optionally, the user may indicate for the telephone calls a priority which defines the compression rate used, when bandwidth is low. For example, under normal conditions, a third telephone call may receive a lower bandwidth than the first two-telephone calls on the modem connection. If, however, the third call requires high quality, the user may provide an instruction to that effect to gateway 108 and accordingly the telephone call receives a high bandwidth. Optionally, the user instruction is provided from telephone 106. Alternatively or additionally, the user instruction is provided through computer 104 and/or through a user interface of gateway 108.

In some embodiments of the invention, the modem connection may be overbooked, i.e., the total maximal bandwidth of the telephone calls passing on the modem connection may be greater than the bandwidth of the modem connection. Generally, in most cases, telephone calls do not carry signals in both directions at the same time. Therefore, on the average, if the modem connection carries, for example, four telephone calls with a slight overbooking, the extent of loss due to the overbooking is expected to be slight. Optionally, the user may define rules to be performed when the samples from the telephone calls require more bandwidth than available. In some embodiments of the invention, a specific call is defined as having a lowest priority and its samples are dropped and/or delayed when necessary. The lowest priority call may be, for example, the last established call or a call from a specific telephone. Alternatively or additionally, samples are dropped, when necessary, from different telephone calls, in order to distribute the reduction in quality between as many as calls as possible.

In some embodiments of the invention, when a user requests to establish a call and the call can be established only with overbooking and/or with a high compression rate, the user is notified that the call can be established only with a low quality. For example, a special signal may be provided to the telephone 106 that was lifted off-hook. The user then optionally chooses whether to establish the call or to wait until a different call is terminated.

Optionally, the determination (406) whether the modem connection may carry an additional telephone call is performed by gateway 108. Alternatively or additionally, the determination (406) is performed by RAS 120.

Referring in more detail to determining (410) whether RAS 120 can handle the telephone call, in some embodiments of the invention, the determination (410) includes determining whether RAS 120 includes resources for an additional processing path (e.g., 322, 324, 328 or 329). Optionally, the determination is performed using any of the methods described in PCT application PCT/IL00/00703, filed Nov. 1, 2000, the disclosure of which is incorporated herein by reference. Alternatively or additionally, any other RAS managing method is used.

Alternatively or additionally, determining (410) whether RAS 120 can handle the telephone call comprises determining whether the service agreement of the user allows utilizing the amount of resources required for handling the connection. Optionally, a user may have a service agreement which limits the number of connections allowed concurrently, the number and/or duration of connections established during a given period, and/or the compression rates allowed for use.

Referring in more detail to selecting (420) the network over which the call is to pass, optionally, the selection is performed responsive to the destination of the call, the time, the date, and/or a priority of the call. For example, low priority calls may be transmitted on the Internet 122 while high priority calls are transmitted on VoIP network 126. In some embodiments of the invention, the selection is performed so as to achieve a cheapest cost. Alternatively or additionally, the selection is performed responsive to the service agreement of the user. For example, a user may be allowed to use only one or more specific networks. Further alternatively or additionally, the selection may be performed based on the time, date, the destination of the call and/or the load on one or more of the networks. Optionally, RAS 120 periodically receives information on the load of the networks and/or the costs and accordingly selects the network.

Similar procedures to those described above with relation to FIG. 4, are optionally used in establishing a fax call, e.g., by fax machine 107. In some embodiments of the invention, fax calls are established the same way as voice calls, optionally without subscriber system 102 being aware if the call is a fax call or a telephone call. After formation of the fax call, fax machine 107 transmits a fax identification signal, as is known in the art. DTMF 216 optionally identifies the fax signal and notifies controller 248, which in turn switches the handling of the call from a voice conversion path 202 to a fax conversion path 233. Alternatively or additionally, fax machine 107 is permanently connected to fax conversion path 233, such that when a call is established through an interface to which fax machine 107 is connected, the call is immediately assigned a fax conversion path 233.

In some embodiments of the invention, responsive to identifying the fax signal, controller 248 transmits a fax notification control packet to controller 325 on the established call. Controller 325 then assigns an appropriate processing path 328 or 329 to the established call, instead of a voice processing path 322 or 324, respectively.

Alternatively to returning (407) a busy signal if the twisted pair is in use, gateway 108 optionally puts the currently active call on hold, establishes a modem connection with RAS 120 and transfers the current call on to the modem connection. Optionally, the remote user is notified of the transfer of the call and is requested to hang up with a promise that the connection will be re-established shortly. In parallel, the new call is established over the modem connection.

Optionally, gateway 108 keeps track of the destination telephone number of calls established through the PSTN so that if necessary to reinitiate the telephone call over the modem connection the user does not need to redial the number. In some embodiments of the invention, the transfer of the current call to the modem connection is performed automatically without consulting the user. Alternatively, the user on the current call is requested to approve the transfer.

FIG. 5 is a flowchart of the acts performed in establishing a telephone call directed to subscriber system 102, in accordance with an embodiment of the present invention. When a request to establish a telephone call with subscriber system 102 is received (500) by RAS 120, RAS 120 determines (502) whether the modem connection is currently active. If (502) the modem connection is not currently active, the call is optionally routed (504) to CO 118. Alternatively, the call is refused. Alternatively or additionally, the user may define whether the call is to be routed through CO 18 or refused. Optionally, the user definitions may depend on the time, date, origin of the call (telephone number) and/or any other relevant parameter.

If (502) the modem connection is currently active, RAS 120 determines (510) whether it can handle the call. If (510) the call cannot be handled by RAS 120, a busy signal is optionally returned (507). If (510) RAS 120 can handle the call, RAS 120 optionally determines (506) whether the modem connection can-carry an additional telephone call. Alternatively or additionally, RAS 120 transmits a call notification message to gateway 108, which determines whether the modem connection can carry an additional telephone call. If (506) the modem connection cannot carry the call a busy signal is optionally returned (507). If (506) the call can be passed on the modem connection, RAS 120 optionally transmits (512) a ringing control packet to gateway 108. Gateway 108 selects (513) a telephone 106 to receive the call and causes (514) an available telephone 106 to ring and when the telephone is answered the establishment of the connection is completed using procedures known in the art.

In some embodiments of the invention, selecting (513) a telephone 106 to receive the call comprises selecting an available telephone. Alternatively or additionally, subscriber system 102 is assigned a plurality of telephone numbers and one or more of the telephone numbers is associated with one or more of the phones 106. In an exemplary embodiment of the present invention, the subscriber system 102 is assigned a telephone number for each telephone 106 and an additional number for all the telephones. Alternatively or additionally, the user may configure gateway 108 with a list stating an order in which the calls directed to one or more telephone numbers are passed to specific telephones 106. The call is directed to the telephone 106 highest in the order which is not busy, if not all the telephones in the list are busy (the list may include fewer than all the telephones 106).

In some embodiments of the invention, the telephone numbers assigned to subscriber system 102 include a group of digits that identify RAS 120 and one or more digits that identify a specific telephone 106, group of telephones and/or order of telephones within system 102. Optionally, a control packet from RAS 120 to gateway 108 carries the entire telephone number. Alternatively, the control packet carries only the one or more digits that identify the specific telephone 106.

Referring in more detail to determining (510) whether RAS 120 can handle the telephone call, optionally the determination is performed similar to that described above in FIG. 4.

Referring in more detail to determining (506) whether the modem connection may carry an additional telephone call, optionally the determination is performed using one or more of the methods described above with reference to FIG. 4. Optionally, the same standards are performed in determining whether to accept an incoming call or to allow initiation of an outgoing call. Alternatively, different standards are used for incoming and outgoing calls. For example, outgoing calls may be allowed even if they cause a higher overbooking rate. In some embodiments of the invention, incoming and outgoing calls undergo different compression rates. Optionally, the compression rate may be chosen responsive to the identity of the remote caller.

In some embodiments of the invention, if after the call is established a fax identification signal is received by RAS 120, controller 325 switches the handling of the call from a voice processing path 322 or 324 to a fax processing path 328 or 329, respectively. In addition, controller 325 optionally transmits a fax notification control packet to controller 248, which in turn transfers the handling of the call to a fax conversion path 233. Optionally, at the establishing of the call, the in coming call was routed to one of telephones 106. When the telephone 106 is lifted by a user, the fax notification control packet is received by controller 248, which notifies the user that the call is a fax call, for example by sounding a fax signal. Optionally, the user answering telephone 106 operates a fax machine located in parallel to the telephone 106. Alternatively, the fax call is transferred manually or automatically to an unused fax machine 107. In some embodiments of the invention, if a user does not answer the call, the call is automatically answered by fax machine 107 and/or by a voice mail box, as is known in the art.

In some embodiments of the invention, controller 325 and/or controller 248 impose limitations on the transmission rate of fax calls passing over the modem connection, in order to limit the bandwidth utilization of the fax calls. In some embodiments of the invention, the user may instruct gateway 200 regarding the QoS of fax calls the user initiates, and accordingly controller 248 determines a maximal transmission rate (e.g., 2,400, 4,800, 9,600) for the fax call. Alternatively or additionally, the maximal transmission rate is determined responsive to the amount of available bandwidth on the modem connection.

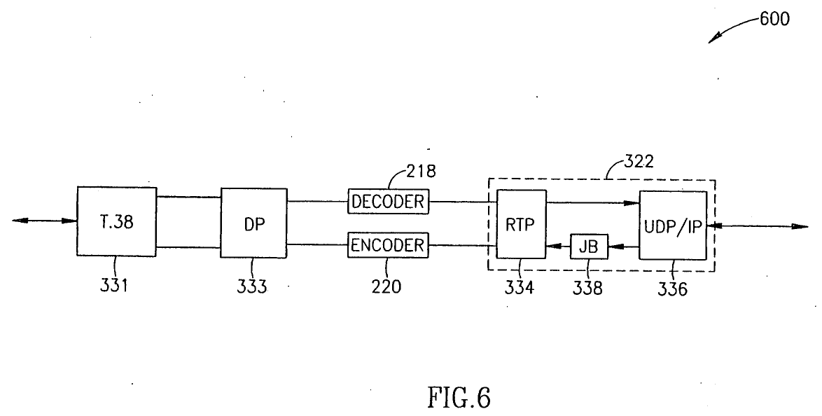

In some embodiments of the invention, when a fax call is established with a remote VoIP gateway which does not support FoIP procedures, gateway 200 and RAS 120 handle the fax call as a VoIP call. Alternatively or additionally, gateway 200 handles the call as a FoIP call and RAS 120 handles the call using a hybrid processing path as is now described, with reference to FIG. 6.

FIG. 6 is a schematic illustration of a FoIP and VoIP hybrid processing path 600, in accordance with an embodiment of the present invention. Processing path 600 comprises a T.38 unit 331, which removes the T.38 encapsulation added by subscriber system 102, and a data pump (DP) 333, which modulates the fax samples back into voice signals as they were produced by fax machine 107. An encoder 220 (and a decoder 218 for the downlink) optionally encodes the voice signals bringing them to a form they would receive if they were handled by subscriber system 102 as voice signals, e.g., to G.711 signals. Processing path 600 optionally further comprises a voice processing path 322, i.e., an RTP unit 334, a jitter buffer (JB) 338 and a UDP/IP unit 336. The signals from conversion path 600 are optionally transmitted on a packet based network, such as Internet 122 and/or VoIP network 126.

In some embodiments of the invention, a subscriber system may keep a continuous modem connection with RAS 120. Optionally, the connection is re-established automatically, for example by DCE-DTE emulator 230 and/or computer 104, when there is a power failure or the connection is otherwise deactivated. Thus, whenever a plurality of telephone connections are desired, the possibility is available. In other embodiments of the invention, the modem connection is established only when data transmission is desired and/or when a plurality of telephone calls are known to be wanted. In still other embodiments of the invention, the modem connection is established during office hours and/or at any other predetermined times. Alternatively or additionally, the modem connection is established whenever a user is in the vicinity of system 102 and/or at least one of the telephones. Alternatively or additionally, only when at least two users are in the vicinity of system 102 is the modem connection automatically established: For example, system 102 may include a presence sensor (e.g., any system for intruder detection) and/or may be connected to light and/or air-conditioning switches of the vicinity of the system.

It is noted that in some embodiments of the invention, RAS 120 does not require dedicated hardware and/or software resources which service only a specific subscriber system 102. That is, when the modem connection with a specific system 102 is not active, there is no idle apparatus of RAS 120 waiting for connection to the specific system 102. In addition, the processing load on RAS 120 is a function of the number of calls actually processed and is not a fixed amount for the time at which the modem connection is active. In some embodiments of the invention, subscriber system 102 is billed by RAS 120 according to a flat rate and/or according to the time at which the modem connection is active, irrespective of the number of telephone calls established. Alternatively or additionally, at least some of the billing is a function of the number of telephone calls established, the duration of the telephone calls and/or the networks carrying the calls. Optionally, the user of subscriber system pays only for outgoing calls. Alternatively or additionally, the user or the remote caller pays RAS 120 also for the incoming calls.

In some embodiments of the invention, in establishing the modem connection a password needs to be entered as is known in the art. Optionally, an additional user ID and/or password must be entered in order to use the telephone service. In some embodiments of the invention, different entities are billed for the modem connection and for the telephone calls. Optionally, system 102 includes card reader which is used to identify the entity to be billed for a specific call and/or for the modem connection.

In some embodiments of the invention, RAS 120 includes a voice mailbox which saves messages received from callers which were not answered by a user. Incoming calls may be directed to the voice mail box instead of being responded to with a busy signal and/or being routed to CO 118. Optionally, the user may determine which calls will be forwarded to the voice mailbox, for example according to the origin of the call, the time, date and/or any other relevant parameter of the call.

It is noted that instead of a fax machine 107, computer 104 (or any other computer) together with a suitable modem may serve as a fax machine. In addition, although the fax processing paths were described as using the T.38 protocol, other methods for transmitting fax signals over modem connections may be used, such as described in PCT application PCT/IL00/00657, filed Oct. 17, 2000, the disclosure of which is incorporated herein by reference.

In some embodiments of the invention, an Internet service provider (ISP) installs RASs 120 in an manner that allows simple upgrading. Optionally, the ISP initially installs a single RAS 120 at a central position. When the single RAS requires upgrading an additional RAS is optionally installed locally near a location from which a large number of connections are received.

It will be appreciated that the above described methods may be varied in many ways, including, performing a plurality of steps concurrently, changing the order of steps and changing the exact implementation used. For example, if determinations 406 and 410 are both performed by server 300, the server may first determine whether the RAS can handle the call and then determine whether the modem connection can carry the call, or the determination may be performed concurrently. In addition, although the above description relates to VoIP packets, the present invention may be used with voice over other packet based networks, such as over ATM and/or frame relay networks. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of converting voice signals into voice packets, comprising:
providing one or more of voice or fax digital signals, at a first location;
processing the provided digital signals at the first location;
transmitting the processed digital signals to a second location;
adding at least one header to the processed digital signals transmitted to the second location, at the second location; and
transmitting the processed digital signals with the added header on a communication network.

2. A method according to claim 1, wherein providing the digital signals comprises receiving analog signals and converting the analog signals into digital signals.

3. A method according to claim 1, wherein providing the digital signals comprises receiving digital signals.

4. A method according to claim 1, wherein processing the provided digital signals comprises compressing the voice digital signals.

5. A method according to claim 4, wherein compressing the voice digital signals comprises compressing according to a compression method selected responsive to at least one parameter of a connection on which the signals are transmitted.

6. A method according to claim 5, wherein the compression method is selected responsive to a utilization rate of the bandwidth of the connection.

7. A method according to claim 5 or claim 6, wherein the compression method is selected responsive to a data rate of the connection.

8. A method according to claim 5, wherein the compression method is selected responsive to a maximal number of telephone and fax calls defined for the connection.

9. A method according to claim 4, comprising changing, for at least one telephone call, the compression method selected for the call, or a parameter of the compression method, during the progress of the call, without disconnecting the call.

10. A method according to claim 4, wherein compressing the voice digital signals comprises compressing using a method different than a compression method used for signals transmitted in an opposite direction on a call to which the compressed signals belong.

11. A method according to claim 1, wherein providing the digital signals comprises providing digital voice signals and wherein processing the provided digital voice signals comprises encoding the voice signals.

12. A method according to claim 1, wherein providing the digital signals comprises providing digital modulated signals and wherein processing the provided digital signals comprises demodulating the digital signals.

13. A method according to claim 1, wherein providing the digital signals comprises providing digital fax signals and wherein processing the provided digital fax signals comprises encapsulating the fax signals into Internet facsimile protocol (IFP) packets.

14. A method according to claim 1, wherein transmitting the processed digital signals to a second location comprises transmitting over a modem connection.

15. A method according to claim 14, wherein transmitting the processed digital signals over a modem connection comprises transmitting over a voice band modem connection.

16. A method according to claim 1, wherein the modem connection is established other than by an instruction from a general purpose computer.

17. A method according to claim 1, wherein transmitting the processed digital signals to a second location comprises transmitting over an ISDN connection.

18. A method according to claim 1, wherein transmitting the processed digital signals to a second location comprises transmitting over a connection which additionally carries data packets.

19. A method according to claim 1, wherein the first and second locations are distanced from each other by at least 100 meters.

20. A method according to claim 1, wherein the first and second locations are not connected directly through a twin pair line.

21. A method according to claim 1, wherein adding at least one header to the processed digital signals transmitted to the second location comprises adding at least one of an IP, TCP, UDP, ATM or RTP header.

22. A method according to claim 1, wherein adding at least one header to the processed digital signals transmitted to the second location comprises adding a header which includes one or more of a source or destination address.

23. A method according to claim 1, comprising:
receiving downstream digital signals, at the second location;
removing at least one header from the received downstream signals; and
transmitting the signals from which the at least one header was removed to the first location.

24. A method according to claim 23, comprising passing the received downstream signals through a jitter buffer in the second location.

25. A method according to claim 1, comprising decoding and re-encoding the signals transmitted to the second location, at the second location.

26. A method according to claim 1, wherein the signals transmitted to the second location are not decoded, at the second location.

27. A method according to claim 1, comprising additionally transmitting to the second location from the first location, voice or fax digital signals to which a header is not added in the second location and which are forwarded from the second location on a switched network.

28. A method according to claim 1, wherein providing one or more of voice or fax digital signals comprises providing signals belonging to a plurality of telephone or fax calls or a combination of one or more telephone calls and one or more fax calls.

29. A method according to claim 28, wherein transmitting the processed digital signals with the added header on a communication network comprises transmitting processed digital signals from at least two different calls on at least two different communication networks.

30. A method according to claim 28, wherein transmitting the processed digital signals with the added header on a communication network comprises transmitting substantially all the processed digital signals on a same communication network.

31. A method according to claim 1, wherein transmitting the processed digital signals with the added header on a communication network comprises transmitting at least some of the processed digital signals with the added header on the Internet.

32. A method according to claim 1, wherein transmitting the processed digital signals with the added header on a communication network comprises transmitting at least some of the processed digital signals with the added header on a VoIP network or an ATM network.

33. A network gateway, comprising:
at least one modem interface adapted to form a modem connection with a remote modem;
at least one multiplexer adapted to extract one or more of voice or fax signals belonging to one or more calls, from signals received over the modem connection;
at least one switched network interface adapted to transmit one or more of voice or fax signals extracted by the multiplexer, over a switched network, to a remote telephone or fax machine; and
at least one packet network interface adapted to transmit one or more of voice or fax signals extracted by the multiplexer to a remote gateway, over at least one packet based network.

34. A gateway according to claim 33, wherein the at least one modem interface comprises at least one voice band modem interface.

35. A gateway according to claim 33, wherein the at least one modem interface comprises at least one ISDN interface.

36. A gateway according to claim 33, wherein the at least one multiplexer is adapted to extract both voice and fax signals from the signals received over the modem connection.

37. A gateway according to claim 33, wherein at any particular time the one or more of voice or fax signals extracted from the modem connection are transmitted either by the switched network interface or by the packet network interface.

38. A gateway according to claim 33, wherein the switched network interface and the packet network interface are adapted to concurrently transmit one or more of voice or fax signals extracted from the modem connection.

39. A gateway according to claim 33, wherein the at least one modem interface is remotely located from a central office servicing the remote modem.

40. A gateway according to claim 33, comprising a selection unit adapted to select a network on which to transmit voice or fax signals of a call passing on the modem connection.

41. A gateway according to claim 40, wherein the selection unit selects the network on which to transmit the voice or fax signals of a call responsive to a time or date of initiation of the call.

42. A gateway according to claim 40, wherein the selection unit selects the network on which to transmit the voice or fax signals of a call responsive to a destination of the call.

43. A gateway according to claim 40, wherein the selection unit selects the network on which to transmit the voice or fax signals responsive to a measure of the load on one or more of the networks.

44. A gateway according to claim 33, wherein the at least one packet network interface is adapted to transmit data packets in addition to the voice or fax signals extracted by the multiplexer.

45. A method of operating a gateway to one or more packet based networks, comprising:
receiving signals over a same modem connection;
separating the received signals to at least a first group and a second group;
applying to the signals of the first group at least one processing task not applied to the second group; and
transmitting the signals of the first and second groups on to one or more packet based networks.

46. A method according to claim 45, wherein the first group of signals comprises one or more of voice or fax signals.

47. A method according to claim 45, wherein applying to the signals of the first group at least one processing task not applied to the second group comprises one or more of decoding the voice signals or demultiplexing the fax signals.

48. A method according to claim 45, wherein applying to the signals of the first group at least one processing task not applied to the second group comprises adding at least one protocol header to packets including the signals of the first group.

49. A method according to claim 45, wherein transmitting the signals of the first and second groups on to one or more packet based networks comprises transmitting the signals of the first and second groups on a same packet based network.

50. A method according to claim 45, wherein transmitting the signals of the first and second groups on to one or more packet based networks comprises transmitting the signals of the first group on a different packet based network than the signals of the second group.

51. A method according to claim 45, wherein receiving signals over a modem connection comprises receiving signals over a voice band modem connection.

52. A method according to claim 45, wherein separating the received signals to at least a first group and a second group comprises separating to at least three groups, the signals of the third group being transmitted on to a switched network.

53. A method according to claim 45, wherein the second group of signals comprises data packets.

54-66. (Cancelled)

67. A method of transmitting voice signals on a modem connection, comprising:
establishing a modem connection;
receiving voice signals of a telephone call;
selecting an encoding method, from a plurality of different voice encoding methods, for encoding the received voice signals, responsive to an estimate of the signals to be transmitted on the modem connection;
encoding the received voice signals according to the selected method; and
transmitting the encoded voice signals on the established modem connection.

68. A method according to claim 67, wherein selecting the encoding method responsive to the estimate of the signals to be transmitted on the modem connection comprises selecting responsive to an estimate of available bandwidth on the modem connection.

69. A method according to claim 67, wherein selecting the encoding method responsive to the estimate of the signals to be transmitted on the modem connection comprises selecting responsive to a number of telephone, fax or both telephone and fax calls passing on the modem connection.

70. A method according to claim 67, wherein selecting the encoding method responsive to the estimate of the signals to be transmitted on the modem connection comprises selecting responsive to a quality of service assigned to at least one telephone or fax call passing on the modem connection.

71. A method according to claim 67, wherein the modem connection carries signals of a plurality of telephone calls whose voice signals are encoded using different encoding methods.

72. A method according to claim 67, comprising changing the selected encoding method of the call without disconnecting the call.

73. A method according to claim 67, wherein the different encoding methods differ in their bandwidth requirements.
